(19) United States
(12) Patent Application Publication
(10) Pub. No.: US 2026/0337724 A1
(43) Pub. Date: Oct. 29, 2026

(54) METHOD OF RARE EARTH AND MINERALS EXTRACTION FROM TIN TAILING

(71) Applicants: Noorhana YAHYA, Ipoh (MY); Franky YASON, Jakarta (ID)

(72) Inventors: Noorhana YAHYA, Ipoh (MY); Franky YASON, Jakarta (ID)

(21) Appl. No.: 19/109,089

(22) PCT Filed: Nov. 8, 2023
(86) PCT No.: PCT/MY2023/050090

§ 371 Date: Mar. 5, 2025

(30) Foreign Application Priority Data
Nov. 8, 2022 (MY) PI2022006289

(51) Int. Cl. C22B 59/00; C01F 17/206; C22B 1/24; C22B 3/08; C22B 3/10; C22B 3/22; C22B 3/44; C22B 34/12; C22B 34/14

(52) U.S. Cl. CPC C22B 59/00; C01F 17/206; C22B 1/24; C22B 3/08; C22B 3/10; C22B 3/22; C22B 3/44; C22B 34/1245; C22B 34/14

(57) ABSTRACT

The disclosure relates to a method to extract RE from tin tailings. The tin tailings sample contain substantial content of other minerals, namely Anatase (21.5%), Rutile (5.3%), Zirconia (10.4%) and Cassiterite (29.4%). Removal of these other minerals prior to RE extraction is important as the inductance, Lp of post-leach remnant sample showed a 37.6% increase from 5936 μH to 8173 μH, that unveils the RE magnetic properties. The present disclosure is associated with capacitive plates that surround the tin tailings that creates in-situ capacitive effect to monitor the removal of non-RE mineral with high chargeability. According to X-Ray Diffraction (XRD) analysis, Anatase content (21.5%) in untreated tailings sample dropped to 0%, which indicates that Anatase has been leached out entirely by using 5M-7M Hydrochloric Acid, HCl under 150 °C to 200 °C thermal condition.

### FIELD OF THE INVENTION

The present invention is related in general to recovery, extraction and/or separation of rare earth elements (REE), and to a method for rare earth extraction from tin tailing.

### BACKGROUND OF THE INVENTION

Globally leading companies in raw materials extraction, storage, and production of its derivatives, actively seek for solutions to reduce the environmental impact in mining sites by repurposing the materials found in tailings hence, to be a part of the circular economy. The application of REE minerals in clean and green technology, which is a wide range of technology-enabled equipment and innovations ranging from renewable energy systems such as wind and solar to electric car technologies and technological improvements that lessen the need for non-renewable resources, is becoming a new source of growth in the global economy.

The REE minerals are required for technologies that are expected to play a major role in fighting climate change. However, they are all susceptible to price fluctuation and scarcity. Therefore, the recovery of REE minerals from mine tailings is being done to compensate for future shortages. Mine tailings are residues of the processing of certain minerals to obtain one or more components of interest. They are made up of heavy metals, water, sand, and fine-grained solid material and are typically deposited in ponds without additional treatment. The reprocessing of mine tailings to extract REE minerals has the potential to limit the mining of new resources while also ensuring the profitable use of waste materials.

Rare earth (REE) elements are found in nearly every technologically advanced product (cell phones, televisions, DVD players, electric vehicles) as well as many low-tech items (oil refining, cigarette lighters, incandescent lighting). However, they are all susceptible to price fluctuation and scarcity. Geological heterogeneity of the rocks mined, and the continuous flow procedures utilized in mineral processing for the past decades catered several tailings samples for analysis, namely B₀, Bₖ and Bₕ. Elemental analysis of acquired tailings samples revealed 34,032 ppm of REE present in sample B₀, whereas 12,104 ppm and 7,466 ppm of REE in samples Bₖ and Bₕ respectively. The highest REE content in sample B₀ has the largest content of Yttrium (13,021 ppm), which is broadly used element in making superconductors and laser, followed by Cerium (8,372 ppm) and Lanthanum (4,418 ppm). Nonetheless, the sample contains significantly huge content of Neodymium (3,235 ppm) and Praseodymium (1,026 ppm) that are crucial in cutting edge technologies development, such as the motor for electric vehicle (EV).

Further, in the state of art, several different methods and apparatuses have been suggested for the extraction of rare earth elements. U.S. Pat. No. 9,115,419B2d disclose a process for the extraction of rare earth elements, including yttrium, from tailings with rich rare earth element content, comprising the steps of leaching the tailings with rich rare earth element content with a lixiviant of hydrochloric acid and magnesium chloride at atmospheric pressure at a temperature of from 90 °C to the boiling point of the solution and at an electric potential (Eh) of at least 200 mV. After a liquid/solids separation step, the solution obtained is subjected to steps for removal of iron and for recovery of rare earth elements. Alternatively, the tailings with rich rare earth element content may be leached with sulphuric acid and liquid obtained subjected to extraction of iron and other impurities. Raffinate obtained may be precipitated with oxalic acid, the cake is dissolved in hydrochloric acid and subjected to solvent extraction for rare earth elements or the raffinate may be subjected to solvent extraction for removal of rare earth elements and then stripped with hydrochloric acid.

Processes that are effective for the recovery of rare earth elements tin tailings and which have low or minimal environmental issues would be beneficial. Such processes should include potential reduce environmental issues and for economic operation of the process. In addition, the processes should be capable of removing other minerals prior to REE extraction from the tailings with rich rare earth element content.

Based on the foregoing there is a need for an improved method for extracting rare earth elements from tin tailing.

### SUMMARY OF THE INVENTION

As will be realized in the following description, the invention is capable of other and different embodiments and its several details are capable of modifications in various respects, all without departing from the scope of the present invention.

To minimize the limitations found in the prior art, and to minimize other limitations that will be apparent upon the reading of the specification, the preferred embodiment of the present invention provides a method for rare earth extraction from tin tailing.

The present invention discloses a method for rare earth extraction from tin tailing comprising the steps of:
crushing the tin tailing and separating heaviest elements to obtain crushed tin tailings without heaviest elements;
chemical leaching of crushed tin tailings (non-REE) of step (a) with Ammonium Sulphate (NH₄)₂SO₄, Hydrochloric Acid, HCl; Sulphuric Acid, H₂SO₄ at a temperature ranging from 150 °C to 260 °C for titania, zirconia and cassiterite with pressure ranging from 7 to 10 bar to obtain NON-REE pregnant leach solution;
precipitation of obtained non-REE pregnant leach solution from chemical leaching cavity with Oxalic Acid, C₂H₂O₄; Ammonium Hydroxide, NH₄OH; Potassium Hydroxide, KOH and those precipitating agents;
filtration and drying of solid precipitate of step (c) prior to elemental analysis for removal of non-REE, impact on REE content and application of further thermodynamics and electromagnetics for REE extraction from chemically leached tin tailings.
subjecting the REE to further separation through step (b) to (d) and solid REE Hydroxide to individual separation of rare earth elements;
sintering the resulting filtered cake to its respective single-phase oxides at temperatures.

### BRIEF DESCRIPTION OF THE DRAWINGS

This invention will be described by way of non-limiting embodiments of the present invention, with reference to the accompanying drawings, in which:

FIG. 1(a) illustrates XRD analysis result for Tailing sample according to an embodiment of the method of the present invention.

FIG. 1(b) depicts X-Ray Diffraction (XRD) analysis of remnant sample (post-leach) according to an embodiment of the method of the present invention.

FIG. 2 illustrates Sn, TiO₂, ZrO₂ and Fe₂O₃ Fe elemental content for B₀, Bₖ and Bₕ according to an embodiment of the method of the present invention.

FIG. 3(a) illustrates different mill types that includes; (A) ball mill, (B) planetary mill, (C) vibratory mill, (D) stirring mill, (E) pin mill and (F) rolling mill according to an embodiment of the method of the present invention.

FIG. 3(b) illustrates optimum speed for ball mill according to an embodiment of the method of the present invention, which is highly dependent on the diameter of the ball mill, number and sizes of the milled balls.

FIG. 4 illustrates schematic of magnetic separator according to an embodiment of the method of the present invention.

FIG. 5(a) depicts the leaching of 50 g B₀ tin tailing with 100 ml of 6M ammonium sulphate solution for 6-9 hours.

FIG. 5(b) illustrates the filtration step of B₀ remnant to obtain leached REE pregnant solution using filter paper according to an embodiment of the method of the present invention.

FIG. 6(a) illustrates white solids (precipitate) can be observed at the bottom of the container after the same pregnant solution is introduced with 1M oxalic acid.

FIG. 6(b) illustrates he filtered 6 M ammonium sulphate leached pregnant solution remained clear after adding 0.5 M oxalic acid for precipitation according to an embodiment of the method of the present invention.

FIG. 7 illustrates formed and dried precipitates according to an embodiment of the method of the present invention.

FIG. 8(a) illustrates schematic diagram for test bed (General Flow Design) according to an embodiment of the method of the present invention.

FIG. 8(b) illustrates schematic diagram of test bed setup (Specific Improvement) according to an embodiment of the method of the present invention, which is also embedded with electro-magnetics (EM) systems.

FIG. 9 illustrates detailed schematics of pressurized thermal chemical leaching cavity according to an embodiment of the method of the present invention.

FIG. 10(a) depicts real test bed setup (Front view) according to an embodiment of the method of the present invention.

FIG. 10(b) illustrates the real test Bed Setup (Side view) according to an embodiment of the method of the present invention.

FIG. 11 depicts Flow Process of Mineral Extraction according to an embodiment of the method of the present invention.

FIG. 12 illustrates Inductance of Bₕ tin tailing, Bₕ remnant leached with catalyst and REE oxalates at various frequency.

FIG. 13 illustrates Quality factor of Bₕ tin tailing, Bₕ remnant leached with catalyst and REE oxalates at various frequency according to an embodiment of the method of the present invention.

FIG. 14 illustrates Inductance comparison of Bₕ tin tailing, Bₕ remnant leached with and without catalyst at 150 Hz according to an embodiment of the method of the present invention.

FIG. 15 depicts Quality factor of Bₕ tin tailing, Bₕ remnant leached with and without catalyst at 150 Hz according to an embodiment of the method of the present invention.

FIG. 16 illustrates Inductance of Bₕ tin tailing and Bₕ post-leaching remnant at different time, 1 hour, 3 hours and 5 hours, measured at different frequency according to an embodiment of the method of the present invention.

FIG. 17 illustrates Quality factor of Bₕ tin tailing and Bₕ post-leaching remnant at different time, 1 hour, 3 hours and 5 hours, measured at different frequency according to an embodiment of the method of the present invention.

FIG. 18 illustrates Inductance of Bₕ tin tailing and Bₕ post-leaching remnant at different molarities, 1M, 3M and 6M, measured at different frequency according to an embodiment of the method of the present invention.

FIG. 19 depicts Quality factor of Bₕ tin tailing and Bₕ post-leaching remnant at different molarities, 1M, 3M and 6M, measured at different frequency according to an embodiment of the method of the present invention.

FIG. 20 illustrates Inductance of Bₕ:Bₖ (1:1) tin tailing mixture and Bₕ:Bₖ (1:1) post-leaching remnant measured at different frequency according to an embodiment of the method of the present invention.

FIG. 21 illustrates Quality factor of Bₕ:Bₖ (1:1) tin tailing mixture and Bₕ:Bₖ (1:1) post-leaching remnant measured at different frequency according to an embodiment of the method of the present invention.

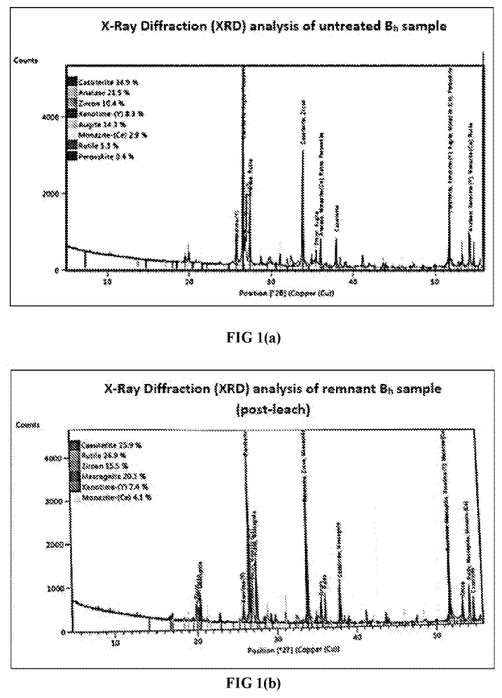

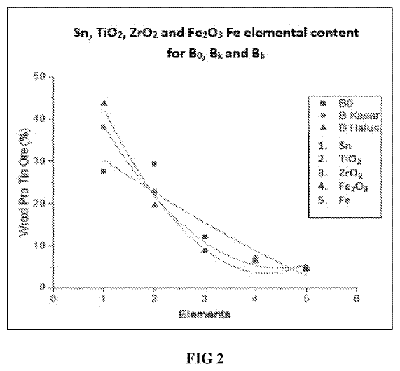

### DETAILED DESCRIPTION OF THE INVENTION

In the following description, reference is made to the accompanying drawings where, by way of illustration, specific embodiments of the invention are shown. It is to be understood that other embodiments may be used, and other changes may be made without departing from the scope of the present invention. Accordingly, the drawings and detailed description are to be regarded as illustrative in nature and not as restrictive.

The present invention discloses a method for rare earth extraction from tin tailing using chemicals, thermodynamics and electro-magnetics comprising the steps of: crushing the tin tailing and separating heaviest elements to obtain crushed tin tailings without heaviest elements;
chemical leaching of crushed tin tailings (non-REE) of step (a) with Ammonium Sulphate (NH₄)₂SO₄, Hydrochloric Acid, HCl; Sulphuric Acid, H₂SO₄ at a temperature ranging from 150 °C to 260 °C for titania, zirconia and cassiterite with pressure ranging from 7 to 10 bar to obtain NON-REE pregnant leach solution;
precipitation of obtained non-REE pregnant leach solution from chemical leaching cavity with Oxalic Acid, C₂H₂O₄; Ammonium Hydroxide, NH₄OH; Potassium Hydroxide, KOH and those precipitating agents;
filtration and drying of solid precipitate of step (c) prior to elemental analysis for removal of non-REE, impact on REE content and application of further thermodynamics and electromagnetics for REE extraction from chemically leached tin tailings.
subjecting the REE to further separation through step (b) to (d) and solid REE Hydroxide to individual separation of rare earth elements;
sintering the resulting filtered cake to its respective single-phase oxides at temperatures.

In accordance with an embodiment of the method of the present invention, the tin tailing is mechanically crushed with crushing period for 6-8 hours that consist of fine and coarse grain tailing particles.

In accordance with an embodiment of the method of the present invention, the crushed tin tailing ranges from fine to coarse particles ranging from 0.03 mm to 1.0 mm and mixed at fine to coarse grain proportion of 1:3.

In accordance with an embodiment of the method of the present invention, the crushed tin tailing heaviest elements of step (a) that have density more than 10 g/cm³ is separated to ensure removal actinides, further consist of Uranium and Thorium.

In accordance with an embodiment of the method of the present invention, the crushed tin tailing heaviest elements of step (a) that have density approximately 6 g/cm³ is separated, Higher than 6 g/cm³ is REE and Cassiterite whereas lower than 6 g/cm³ is Zirconia and Titania.

In accordance with an embodiment of the method of the present invention, the crushed tin tailing heaviest elements of step (a) of density separation comprises Rutile and Zircon separation through density variation, whereby larger density ranging from 5 g/cm³ and 6 g/cm³.

In accordance with an embodiment of the method of the present invention, the crushed tin tailing heaviest elements of step (a) having REE and Cassiterite is separated by magnetic separation by using magnetic separator, where the high magnetic element (REE) is separated from low magnetic element Cassiterite.

In accordance with an embodiment of the method of the present invention, the crushed tin tailing heaviest elements of step (a) having Monazite and Xenotime are further separated through magnetic separation technology under high magnetic flux density (<0.5 Tesla).

In accordance with an embodiment of the method of the present invention, the non-REE are minerals selected from the group comprising titania, zirconia and cassiterite, which will be leached first under chemical, thermodynamics and electro-magnetics conditions, followed by acquiring pregnant leach solution of REE that is subjected to individual separation of rare earth Cerium, Neodymium, Praseodymium, Lanthanum and Yttrium.

In accordance with an embodiment of the method of the present invention, the step (b) of chemical leaching of crushed tin tailings (non-REE) (A) with Ammonium Sulphate (NH₄)₂SO₄; (B) Hydrochloric Acid, HCl; (C) Sulphuric Acid, H₂SO₄ at a temperature ranging from 150 °C to 260 °C for titania, zirconia and cassiterite with pressure ranging from 7 to 10 bar.

In accordance with an embodiment of the method of the present invention, the chemical leaching of crushed tin tailings (non-REE) is in 200 to 600 mesh sieve and double blade propeller with 120 rpm to 150 rpm to obtain pressurized thermal chemical leaching cavity to ensure the consistent mixing of leaching chemical and tailings under closed high temperature pressurized automation using 150 ml of water then second leach take place range of molarity is 5M to 11M of HCl.

In accordance with an embodiment of the method of the present invention, the chemical leaching cavity is controlled from optionally with a pressure limit up to 20 bars for designs modifications.

In accordance with an embodiment of the method of the present invention, the pressurized thermal chemical leaching cavity associated with the micro sieve is filled with leaching chemical (liquid) to tin tailing (solid) to air (gas) ratio of 2:1:2 to mimic the chemical and thermodynamics system.

In accordance with an embodiment of the method of the present invention, the pressurized thermal chemical leaching cavity is associated with solenoid that creates in-situ high magnetic flux density onto the tin tailing, generated magnetic flux disturbs and weaken the intermolecular bond that includes (A) Phosphate Bond; (B) Carbonate Bond; that bind the REE in stable form.

In accordance with an embodiment of the method of the present invention, the number of turns of solenoid to build high magnetic flux density comprised of but not limited to (a) 15 turns; (b) 30 turns; (c) 50 turns.

In accordance with an embodiment of the method of the present invention, the pressurized thermal chemical leaching cavity is associated with capacitive plates that surround the tin tailings that creates in-situ capacitive effect changes during pressurized thermal chemical leaching onto the tailing.

In accordance with an embodiment of the method of the present invention, the pressurized thermal chemical leaching cavity is associated with Resistivity probe that placed into the tin tailings that creates in-situ resistance measurement during pressurized thermal chemical leaching onto the tailing.

In accordance with an embodiment of the method of the present invention, the chemical leaching of crushed tin tailings (Titania) performed for 6-9 hours by chemical that includes (A) Ammonium Sulphate, (NH₄)₂SO₄; (B) Hydrochloric Acid, HCl; (C) Sulphuric Acid, H₂SO₄; at different molarities 5M to 7M with 150 °C to 200 °C thermal condition.

In accordance with an embodiment of the method of the present invention, the chemical used for Titania (Rutile and Anatase) precipitation from pregnant leach solution includes (A) Oxalic Acid, C₂H₂O₄; (B) Ammonium Hydroxide, NH₄OH; Potassium Hydroxide, KOH with molarity ranging from 1M to 4M at pH 2.0 to 4.0 and pH 4.4 to 6.8 respectively.

In accordance with an embodiment of the method of the present invention, the pressurized thermal chemical leaching cavity for Titania is associated with the micro sieve, which is filled with leaching chemical (liquid) to tin tailing (solid) to air (gas) ratio of 2:1:2 to mimic the chemical and thermodynamics system.

In accordance with an embodiment of the method of the present invention, the chemical leaching of crushed tin tailings (Zirconia) is performed for 6 to 9 hours by chemical that includes (A) Ammonium Sulphate, (NH₄)₂SO₄; (B) Hydrochloric Acid, HCl; (C) Sulphuric Acid, H₂SO₄; at different molarities from 7M to 9M at temperature range of 210 °C to 230 °C.

In accordance with an embodiment of the method of the present invention, the chemical used to precipitate (Zirconia) REE in pregnant solution includes (A) Oxalic Acid, C₂H₂O₄; (B) Ammonium Hydroxide, NH₄OH; molarity is ranging from 0.5M to 1M for Oxalic Acid, C₂H₂O₄ and for Ammonium Hydroxide, NH₄OH is 4M to 8M with thermal condition 40 °C to 70 °C.

In accordance with an embodiment of the method of the present invention, the pressurized thermal chemical leaching cavity for Zirconia is associated with the micro sieve, is filled with leaching chemical (liquid) to tin tailing (solid) to air (gas) ratio of 2:1:2 to mimic the chemical and thermodynamics system.

In accordance with an embodiment of the method of the present invention, the chemical leaching of crushed tin tailings (Cassiterite) is performed for 6 to 9 hours by chemical that includes (A) Ammonium Sulphate, (NH₄)₂SO₄; (B) Hydrochloric Acid, HCl; (C) Sulphuric Acid, H₂SO₄; at different molarities. at varies molarities at 9M to 11M, 240 °C to 260 °C thermal condition.

In accordance with an embodiment of the method of the present invention, the chemical used to precipitate cassiterite in pregnant solution includes (A) Oxalic Acid, C₂H₂O₄; (B) Ammonium Hydroxide, NH₄OH; Potassium Hydroxide, KOH with molarity ranging from 1M to 4M at pH 8.0 to 9.0 with thermal condition 40 °C to 70 °C.

In accordance with an embodiment of the method of the present invention, the pressurized thermal chemical leaching cavity for Cassiterite is associated with the micro sieve, is filled with leaching chemical (liquid) to tin tailing (solid) to air (gas) ratio of 2:1:2 to mimic the chemical and thermodynamics system.

In accordance with an embodiment of the method of the present invention, the precipitated REE cake (solid) of step (e) is further processed with dissolution at controlled temperature range from 125 °C-135 °C with varies molarities of Nitric Acid, HNO₃ ranging from (A) 8M; (B) 9M; (C) 10M.

In accordance with an embodiment of the method of the present invention, the individual REE cake (solid) of step (e) separation is conducted with Hydrochloric Acid, HCl as leaching agent, precipitation for individual separation using 5M to 7M Ammonium Hydroxide, NH₄OH at pH 3.8-4.0 to strip out Cerium and at pH 8.0-8.5 to strip out Neodymium and Praseodymium, then, use precipitation agent 1M-3M Oxalic Acid, C₂H₂O₄ to extract Lanthanum.

In accordance with an embodiment of the method of the present invention, the individual solid REE Hydroxide of step (e) separation is conducting using 12M-16M Sulphuric Acid, H₂SO₄ as leaching agent, precipitation for individual separation using 5M to 7M Ammonium Hydroxide, NH₄OH at pH 6.0-6.5 and pH 7.5-8.0 to strip out Yttrium.

In accordance with an embodiment of the method of the present invention, the Anatase content (21.5%) in untreated tin tailing dropped to 0% whereby Anatase is leached out entirely with 5M-7M Hydrochloric Acid, HCl under 180 °C to 200 °C thermal condition.

In accordance with an embodiment of the present invention, the method for rare earth extraction is from tin tailing using chemicals, thermodynamics and electro-magnetics Herein, “comprising” means the term “comprising” and certain ingredients are defined as “consisting of” and “consisting essentially of”.

Herein “about” will be understood by persons of ordinary skill in the art and will vary to some extent on the context in which the term is used, “about” will mean up to plus or minus of the particular-term pharmaceutically acceptable ranges.

The invention is described in detail herein below with respect to the following examples, which are provided merely for illustration and are not intended to restrict scope of invention in any manner. Any embodiment that is apparent to a person skilled in the art is deemed to fall within the scope of present invention.

### Working Examples

Method of Rare Earth and Mineral Extraction from Tin Tailing Using Thermodynamics & Electro-Magnetics

### Methodology

### Geochemical Analysis of Tailing Samples.

Preliminary studies on the tailings sample were performed via elemental analysis to determine the rare earth earth (REE) content in the soil samples. The samples of soils were tested with three type analysis and the REE content (Table 1) varies tremendously for each sample. This is expected to be the effects of the tailings upon the mechanical and chemical processing for tin extraction and it will be analysed accordingly in further parts of this patents.

TABLE 1
ICP-MS analysis result of sample.

| | B₀ | Content | Bₖ | Content | Bₕ | Content |
|---|---|---|---|---|---|---|
| | Value | by percent | Value | by percent | Value | by percent |
| Element | (ppm) | (%) | (ppm) | (%) | (ppm) | (%) |
| Yttrium, Y | 13021.00 | 38.26 | 5820.00 | 48.08 | 3999.00 | 53.56 |
| Cerium, Ce | 8372.00 | 24.60 | 2285.00 | 18.88 | 1148.00 | 15.38 |
| Lanthanum, La | 4418.00 | 12.98 | 1199.00 | 9.91 | 608.00 | 8.14 |
| Neodymium, Nd | 3235.00 | 9.51 | 921.00 | 7.61 | 471.00 | 6.31 |
| Praseodymium, Pr | 1026.00 | 3.01 | 359.00 | 2.97 | 253.00 | 3.39 |
| Dysprosium, Dy | 840.00 | 2.47 | 283.00 | 2.34 | 203.00 | 2.72 |
| Samarium, Sm | 730.00 | 2.15 | 265.00 | 2.19 | 172.00 | 2.30 |
| Gadolinium, Gd | 683.00 | 2.01 | 252.00 | 2.08 | 157.00 | 2.10 |
| Ytterbium, Yb | 603.00 | 1.77 | 235.00 | 1.94 | 142.00 | 1.90 |
| Erbium, Er | 536.00 | 1.57 | 233.00 | 1.92 | 125.00 | 1.67 |
| Terbium, Tb | 139.00 | 0.41 | 73.20 | 0.60 | 52.40 | 0.70 |
| Holmium, Ho | 117.00 | 0.34 | 53.90 | 0.45 | 40.10 | 0.54 |
| Thulium, Tm | 89.30 | 0.26 | 45.10 | 0.37 | 36.30 | 0.49 |
| Scandium, Sc | 86.10 | 0.25 | 39.20 | 0.32 | 30.40 | 0.41 |
| Lutetium, Lu | 71.70 | 0.21 | 38.40 | 0.32 | 28.90 | 0.39 |
| Europium, Eu | 5.74 | 0.02 | 2.42 | 0.02 | 1.45 | 0.02 |
| total REE | 34032 | 100 | 12104 | 100 | 7466 | 100 |
| Thorium, Th | 1145.00 | | 367.00 | | 244.00 | |
| Uranium, U | 324.00 | | 126.00 | | 106.00 | |

Inductive coupled plasma-mass spectrometry (ICP-MS) result (Table 1), a higher mineral content that was found in the tin tailings indicates that the tin tailing is comprised of Yttrium (Y), Cerium (Ce), Lanthanum (La), Neodymium (Nd) and Praseodymium (Pr). There are more than 80% of light rare earth element (LREE) compared to heavy rare earth element (HREE) for each tin tailing (B₀, Bₖ and Bₕ) indicating that the rare earth elements present are bonded with phosphate in nature, which is Monazite. Actinide is a radioactive group that is comprised of Thorium (Th) and Uranium (U) are found in minor contents in the tin tailings. These radioactive elements can be removed accordingly.

### XRF Analysis Result for Sample.

TABLE 2
depicts XRF analysis result for Tailing sample.
Tailings Samples

| | | |
|---|---|---|
| B₀ | Bₖ | Bₕ |

| | Content | | Content | | Content |
|---|---|---|---|---|---|
| Element | (%) | Element | (%) | Element | (%) |
| SnO₂ | 29.43 | TiO₂ | 38.11 | TiO₂ | 43.64 |
| TiO₂ | 27.59 | SnO₂ | 22.82 | SnO₂ | 19.56 |
| ZrO₂ | 12.07 | ZrO₂ | 8.77 | ZrO₂ | 8.82 |
| SiO₂ | 7.15 | SiO₂ | 8.12 | SiO₂ | 8.8 |
| Fe₂O₃ | 6.64 | Fe₂O₃ | 7.1 | Fe₂O₃ | 6.37 |
| Fe | 4.64 | Fe | 4.96 | Fe | 4.46 |
| P₂O₅ | 1.88 | P₂O₅ | 1.52 | Al₂O₃ | 1.46 |
| BaO | 1.02 | Al₂O₃ | 1.22 | P₂O₅ | 1.27 |
| SO₃ | 0.78 | SO₃ | 0.95 | Mn₃O₄ | 0.49 |
| Al₂O₃ | 0.56 | BaO | 0.65 | BaO | 0.48 |
| Mn₃O₄ | 0.45 | Mn₃O₄ | 0.5 | MnO | 0.45 |
| MnO | 0.42 | MnO | 0.46 | Mn | 0.35 |
| P | 0.41 | S | 0.38 | P | 0.28 |
| Mn | 0.32 | Mn | 0.36 | Cr₂O₃ | 0.19 |
| S | 0.31 | P | 0.33 | HFO₂ | 0.19 |
| HfO₂ | 0.25 | Cr₂O₃ | 0.18 | WO₃ | 0.16 |
| CaO | 0.17 | HfO2 | 0.18 | CaO | 0.13 |
| WO3 | 0.15 | WO3 | 0.15 | MgO | 0.13 |
| Cr2O3 | 0.13 | CaO | 0.13 | V₂O₅ | 0.1 |
| MgO | 0.11 | MgO | 0.12 | V | 0.05 |
| Bi2O3 | 0.07 | V2O5 | 0.09 | SO₃ | 0.05 |
| V2O5 | 0.05 | Bi2O3 | 0.05 | Bi₂O₃ | 0.04 |
| PbO | 0.04 | V | 0.05 | PbO | 0.03 |
| V | 0.03 | PbO | 0.04 | S | 0.02 |
| NiO | 0.02 | AS2O3 | 0.03 | ZnO | 0.02 |
| ZnO | 0.02 | ZnO | 0.02 | Na₂O | 0.02 |
| As2O3 | 0.01 | Na2O | 0.02 | NiO | 0.01 |
| CuO | 0.01 | NiO | 0.01 | CuO | 0 |
| Na2O | −0.01 | CuO | 0.01 | As₂O₃ | 0 |
| SrO | −0.01 | SrO | −0.01 | SrO | −0.02 |
| K2O | −0.27 | K2O | −0.19 | K₂O | −0.15 |
| | 96.49 | | 97.25 | | 97.51 |

Titanium dioxide (TiO₂), Zirconium dioxide (ZrO₂) and Tin oxide (SnO₂) were observed from B₀, Bₖ and Bₕ tin tailings using X-ray Fluorescence (XRF) analytical equipment (Table 2). TiO₂ was detected from Bₖ and Bₕ in a substantially high content such as 38.11% and 43.64% respectively, however B₀ tailings samples 27.59% of TiO₂ is observed. The extraction of TiO₂ needs to be scrutinized. The content of ZrO₂ is highest in B₀ tin tailing (12.07%), while approximately 8.8% in Bₖ and Bₕ tin tailings. On the other hand, SnO₂ content is the most in B₀, which is about 29.43%, while 22.82% and 19.56% in Bₖ and Bₕ tin tailings respectively. This indicates that the processing method in the past centuries in tin mine is not technologically advanced and valuable minerals, TiO₂, ZrO₂ and SnO₂ especially, can further be extracted and transformed commercially into value-added products such as in nanotechnology industry.

For these tin tailings region, the highest content mineral in tin tailing sample is titanium dioxide (TiO₂) compared with other minerals. When these oxides are leached out successfully, the remnants (Bₖ and Bₕ), which comprises REE minerals can be extracted.

### Mechanical Crushing & Magnetic Separation

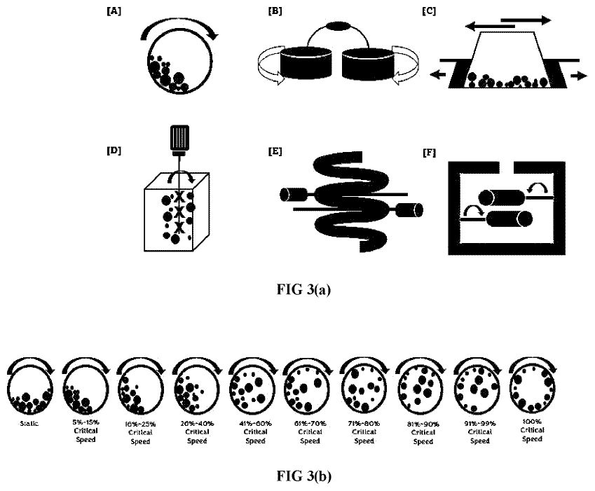

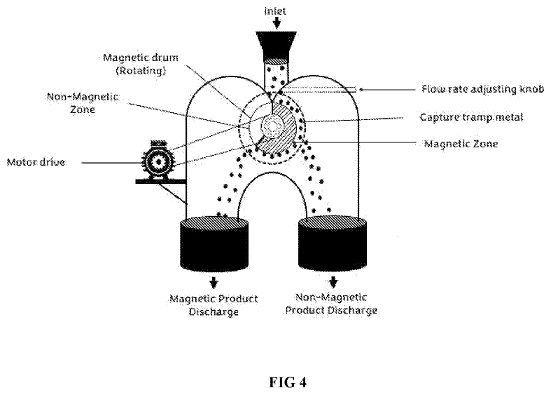

Mechanical crushing is a method of smack of the particles such as tailing samples to provide high surface area for chemical reaction. The smaller the particles, the easier the reaction to happen due to high surface area so that the reaction will happen rapidly compared to big particles. Besides, mechanical crushing also will provide separation of the composition of the tailings sample which in tailings contain monazite and xenotime and the separation can be done easier in magnetic separation (Next Process) since all the element composition stand by itself due to fracturing from mechanical crusher. There are a six crusher/mill that are commonly used in lab scale and industry available which can be seen in FIG. 3(a).

The most common used is ball mill where the optimum speed is 60%-70% out of critical speed because when achieved the critical speed, the centrifugal force will be bigger than gravitational force and crushing process will not be efficient due to ball inside mill only stick to the wall as depicted in FIG. 3(b).

The average size of tailings sample particle (Table 3) that B_{new} has the highest particle size which 0.640 mm and Bₕ is the smallest particles with 0.044 mm. The size reduction from B₀ to Bₖ is about 40% the size reduces from 0.102 mm to 0.061 mm. Hence, B₀ has the largest number of REE which 34,032 ppm.

TABLE 3
Average particle size of B_{new}, B₀, Bₖ, Bₕ.

| Sample | B_{new} | B₀ | Bₖ | Bₕ |
|---|---|---|---|---|
| Particle | 1.000 | 0.400 | 0.200 | 0.140 |
| Size (mm) | 0.800 | 0.160 | 0.050 | 0.035 |
| | 0.700 | 0.080 | 0.030 | 0.021 |
| | 1.100 | 0.050 | 0.040 | 0.028 |
| | 0.500 | 0.030 | 0.060 | 0.042 |
| | 0.200 | 0.040 | 0.070 | 0.049 |
| | 0.800 | 0.060 | 0.050 | 0.035 |
| | 0.600 | 0.090 | 0.030 | 0.021 |
| | 0.200 | 0.060 | 0.040 | 0.028 |
| | 0.500 | 0.050 | 0.040 | 0.040 |
| Average | 0.640 | 0.102 | 0.061 | 0.044 |
| Particle | | | | |
| Size (mm) | | | | |

TABLE 4
Molecular content percentage of B₀, Bₖ and Bₕ.

| | Weightage | | Weightage |
|---|---|---|---|
| MONAZITE | (%) | XENOTIME | (%) |
| Lanthanum Phosphate | 15.59 | Yttrium (Y) | 60 |
| (LaPO₄) | | | |
| Cerium Phosphate (CePO₄) | 37.23 | Dysprosium | 7.5 |
| | | (Dy) | |
| Praseodymium Phosphate | 3.51 | Gadolinium | 3.6 |
| (PrPO₄) | | (Gd) | |
| Neodymium Phosphate | 12.94 | Lutetium (Lu) | 0.63 |
| (NdPO₄) | | | |
| Samarium Phosphate | 2.28 | Samarium | 1.2 |
| (SmPO₄) | | (Sm) | |
| Gadolinium Phosphate | 2.27 | Europium | 0.01 |
| (GdPO₄) | | (Eu) | |
| Dysprosium Phosphate | 1.17 | Ytterbium | 6.0 |
| (DyPO₄) | | (Yb) | |
| Erbium Phosphate (ErPO₄) | 0.46 | Terbium (Tb) | 1.0 |
| Ytterbium Phosphate (YbPO₄) | 0.35 | Holmium | 2.0 |
| | | (Ho) | |

The tin tailings, B₀, Bₖ and Bₕ samples contain Monazites, a phosphate mineral that contains rare earth elements (REE), which shows the molecular content of Lanthanum Phosphate (15.58%), Cerium Phosphate (37.23%), Praseodymium Phosphate (3.52%), Neodymium Phosphate (12.94%) majorly (Table 4). Referring to composition of monazite and xenotime, Yttrium, carries a molecular weightage of 60% in Xenotime mineral.

TABLE 5
Composition of Monazite and Xenotime for B₀, Bₖ and Bₕ.

| | B₀ | Content | Bₖ | Content | Bₕ | Content |
|---|---|---|---|---|---|---|
| | Value | by percent | Value | by percent | Value | by percent |
| Element | (ppm) | (%) | (ppm) | (%) | (ppm) | (%) |
| Yttrium, Y | 13021.00 | 38.26 | 5820.00 | 48.08 | 3999.00 | 53.56 |
| Cerium, Ce | 8372.00 | 24.60 | 2285.00 | 18.88 | 1148.00 | 15.38 |
| Lanthanum, La | 4418.00 | 12.98 | 1199.00 | 9.91 | 608.00 | 8.14 |
| Neodymium, Nd | 3235.00 | 9.51 | 921.00 | 7.61 | 471.00 | 6.31 |
| Praseodymium, Pr | 1026.00 | 3.01 | 359.00 | 2.97 | 253.00 | 3.39 |
| Dysprosium, Dy | 840.00 | 2.47 | 283.00 | 2.34 | 203.00 | 2.72 |
| Samarium, Sm | 730.00 | 2.15 | 265.00 | 2.19 | 172.00 | 2.30 |
| Gadolinium, Gd | 683.00 | 2.01 | 252.00 | 2.08 | 157.00 | 2.10 |
| Ytterbium, Yb | 603.00 | 1.77 | 235.00 | 1.94 | 142.00 | 1.90 |
| Erbium, Er | 536.00 | 1.57 | 233.00 | 1.92 | 125.00 | 1.67 |
| Terbium, Tb | 139.00 | 0.41 | 73.20 | 0.60 | 52.40 | 0.70 |
| Holmium, Ho | 117.00 | 0.34 | 53.90 | 0.45 | 40.10 | 0.54 |
| Thulium, Tm | 89.30 | 0.26 | 45.10 | 0.37 | 36.30 | 0.49 |
| Scandium, Sc | 86.10 | 0.25 | 39.20 | 0.32 | 30.40 | 0.41 |
| Lutetium, Lu | 71.70 | 0.21 | 38.40 | 0.32 | 28.90 | 0.39 |
| Europium, Eu | 5.74 | 0.02 | 2.42 | 0.02 | 1.45 | 0.02 |
| total REE | 34032 | 100 | 12104 | 100 | 7466 | 100 |
| Thorium, Th | 1145.00 | | 367.00 | | 244.00 | |
| Uranium, U | 324.00 | | 126.00 | | 106.00 | |

After crushing the sample, the crushed sample will be put in magnetic separator which will be separation by their magnetic strength using magnetic separator. High magnetic element will be attracted to the magnet component (FIG 4), but the low magnetic strength will fall and then the tailing can be further process following the magnetic strength. Monazites have higher magnetic strength, and four elements are extracted which are cerium (Ce), Neodymium (Nd), Praseodymium (Pr) and Lanthanum (La). The low magnetic phosphates and all non-magnetic minerals will fall and will be discharged.

The schematic of magnetic separator is represented at FIG. 4.

### Chemical Leaching & Precipitation at Ambient Condition

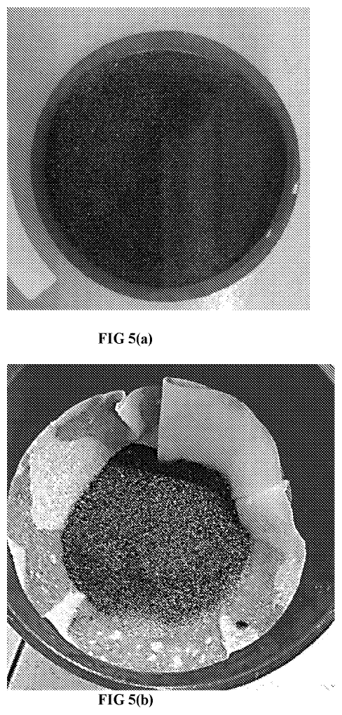

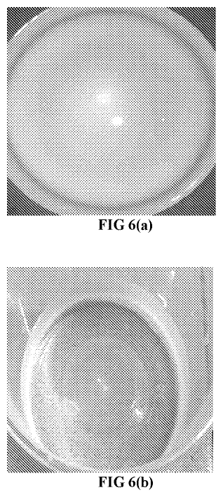

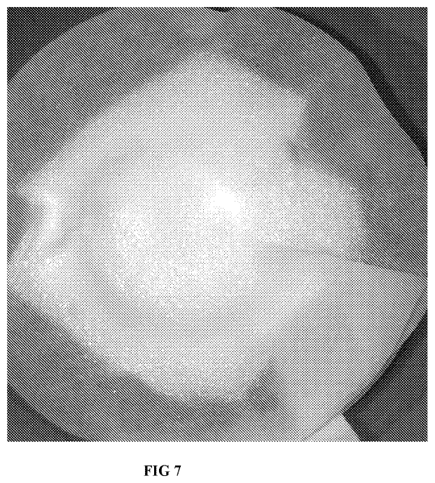

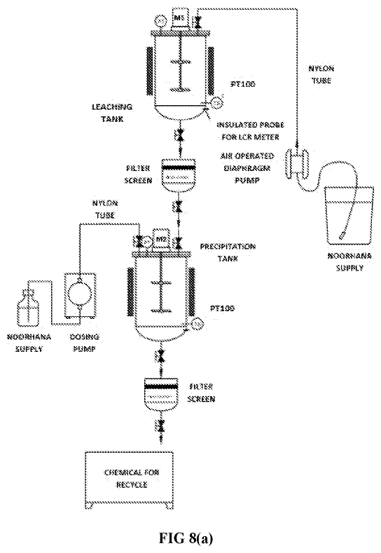

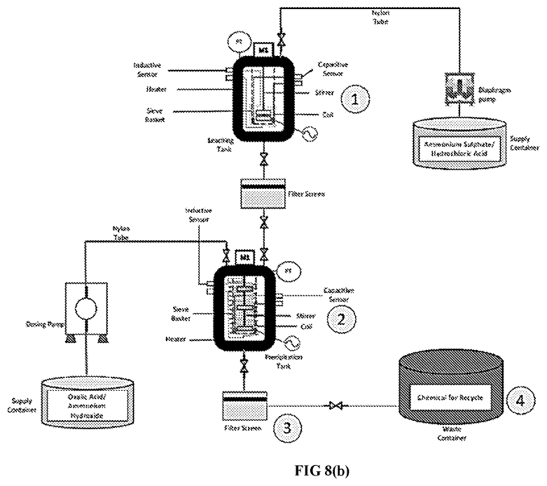

The tin tailings sample B₀ is leached under concentrated ammonium sulphate (6M, 8M, and 10M), then upon filtering the pregnant leach solution from remnant, oxalic acid (0.5M, 1M, 2M, 4M, and 6M) precipitation is conducted to obtain the cake (REE oxalates). The saturation point of ammonium sulphate is achieved beyond 8M, while 2M is the saturation point for oxalic acid before forming crystals in the access under ambient temperature (40 °C) condition. Crystal-like precipitates observed as the experiment after the pregnant leach solution is precipitated. The 6M ammonium sulphate leached the tin tailing and form RE (FIG. 5(a)) sulphate solution, which is then filtered ((FIG. 5(b)) and precipitated with 1M oxalic acid, solid crystals formed. Whereas no significant changes observed when the pregnant leach solution is with 0.5M oxalic acid and solution retains clear form (FIG. 6(b)).

As the formed precipitates (FIG. 7) from 6M ammonium sulphate leached RE pregnant solution added with 1M oxalic acid, settled at the bottom of container, the precipitate is filtered out using filter paper and dried for further ICP-MS analysis. Ammonium sulphate leaching at 6 M and precipitated at 1M oxalic acid yielded some precipitants which was achieved at ambient condition (40 °C). More leaching with different molarity and type of acid were conducted to ensure TiO₂, ZrO₂ and SnO₂, elements were leached out so that the REE content can be easily extracted after leaching process is completed. Subsequent studies on density and particle size were conducted to ensure the physical parameters are well understood. It should be noted that the focus is to remove the non-REE, namely, cassiterite, Titania and Zirconia are removed first. This requires less excessive chemical molarity as well as better purity.

### Development of Rare Earth (RE) Solvent Extraction (SX) Prototype.

1. Design and develop test bed to analyze the prototype system to project RE extraction at proposed pilot plant according to the optimized parameters of ideal system with the highest RE recovery.
2. Analyze and optimize test bed and prototype parameters in processing higher volume of tin mine tailings to predict pilot plant operating conditions.

The development of testbed (First version) in lab scale environment involves two major system of RE solvent extraction, which are the chemical leaching setup and pregnant solution precipitation setup. The 16M Hydrochloric acid will be pump into leaching tank that contain tailings sample with 1:3 Solid to acid ratio and the stirrer to increase chemical reaction efficiency. The pregnant solution then will be flow to precipitation tank and tailings will be filtered and precipitate with 17M Ammonium Hydroxide using dosing pump with flow rate control. This is to remove actinides and further precipitation to obtain REE cake (solid). The REE cake will be filtered and will proceed the individual separation in lab scale. The development of testbed (second version) is described here. The main process has 2 major component which are the leaching and precipitation processes. The major modification is to design a sieve with the correct dimension. The stirrer has been modified to ensure mixing during leaching process is optimized and to ensure the pregnant leach solution can flow to the precipitation tank. This design is more convenient to take out the tailing sample after the pregnant solution flow to precipitation tank. Capacitance and inductance can be measured in-situ with some modifications applicable to precipitation, but the length of coil has covered the whole sieve.

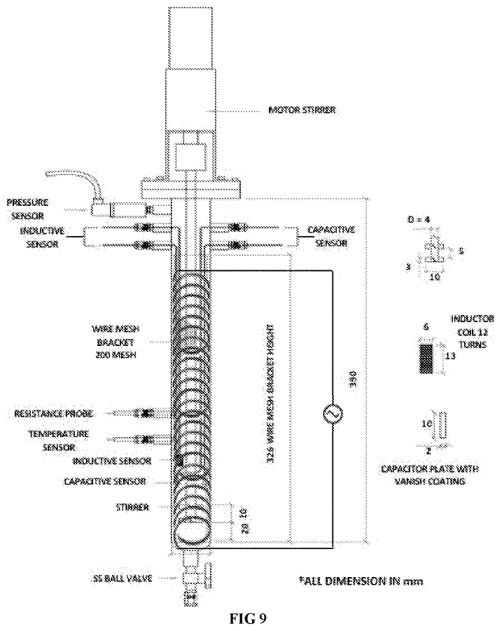

FIG. 9 depicts detailed schematics of pressurized thermal chemical leaching cavity. The close-up of leaching tank where the sieve is installed to place the tin tailings sample and associated stirrer to ensure an optimum stirring of the tin tailing sample during leaching process. The installed pressure sensor is to detect the pressure during the leaching process. In-situ capacitive and inductance effect can be measured while the leaching process is conducted to monitor the changes in tin tailings properties under chemical, thermodynamics, and electro-magnetics condition.

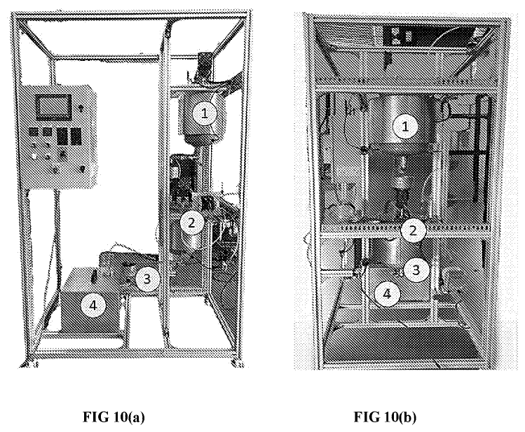

Real test bed setup front view (FIG. 10(a)) and real test bed setup from side view (FIG. 10(b)). The leaching and precipitation processes will be using automated control panel, where the temperature, stirrer speed and dosing rate for precipitation can be controlled remotely. Pumping hydrochloric acid into leaching tank is using air operated diaphragm pump following the ratio 1:3 tailings (solid) to chemical (liquid). After the leaching process is completed, ball valve is to allow pregnant leach solution to flow from leaching tank to precipitation tank. The fixed rate for dosing is 400 mL/minute and there is the timer to manipulate the dosing pump rate. The trapped and filtered REE cake (solid) will be further analyzed for individual separation.

### Parameters Optimization Via Data Analytics Approach

Parameters optimization plays a big role in any business or production since that can lead to better efficiency and optimized results overall. For the Monazite leaching process (Table 6), 14M-16M hydrochloric acid is used with 1:2 tin tailing (solid) to leaching chemical (liquid) ratio at 130 °C to 150 °C. Precipitation of pregnant leach solution is conducted using 14M-17M Ammonium Hydroxide and formed REE cake (solid), which will be dissolved with 8M to 10M Nitric acid at 125 °C to 135 °C. Individual separation of REE is performed via 5M to 7M Ammonium Hydroxide precipitation at pH 3.8-4.0 for Cerium (Ce) and pH 8.0-8.5 for Neodymium (Nd) and Praseodymium (Pr) respectively, whereas Lanthanum is precipitated by using 1M-3M Oxalic Acid.

TABLE 6
Parameters for Monazite Extraction.
PARAMETERS (Monazite Extraction)

| | |
|---|---|
| Leaching Process | 11M-13M HCL; 280 °C-320 °C; |
| | 1:3 Solid to Acid ratio |
| Precipitation | 14M-17M NH₄OH |
| Dissolution | 8M-10M HNO₃; 125 °C-135 °C |
| Precipitation (Individual | pH 3.8-4.0; 5M-7M NH₄OH; 40 °C- |
| Separation, Cerium) | 70 °C |
| Precipitation (Individual | pH 8.0-8.5; 5M-7M NH₄OH; 40 °C- |
| Separation, Neodymium and | 70 °C |
| Praseodymium) | |
| Precipitation (Individual | 1M-3M H₂C₂O₄; 40 °C-70 °C; |
| Separation, Lanthanum) | Further Precipitation |

TABLE 7
Parameters for Xenotime Extraction.
PARAMETERS (Xenotime Extraction)

| | |
|---|---|
| Leaching Process | 13M-15M H₂SO₄; 380 °C-420 °C; |
| | 1:3 Solid to Acid ratio |
| Precipitation | 14M-17M NH₄OH |
| Dissolution | 8M-10M HNO₃; 125 °C-135 °C |
| Precipitation (Individual | pH 6.0-6.5; 5M-7M NH₄OH; 40 °C- |
| Separation, | 70 °C |
| Yttrium) | pH 7.5-8.0; 5M-7M NH₄OH; 40 °C- |
| | 70 °C |

For leaching process of Xenotime (Table 7), 13M to 15M Sulphuric Acid will leach the tin tailings at 380 °C to 420 °C and the pregnant leach solution is precipitated using 14M to 17M ammonium hydroxide. The formed REE cake (solid) is dissolved via 8M to 10M nitric acid at 125 °C to 135 °C. Individual precipitation of Yttrium is conducted at pH 6.0 to 6.5 and pH 7.5 to 8.0 respectively using 5M-7M ammonium hydroxide.

TABLE 8
Parameters for Titania Extraction (non-REE).
PARAMETERS (Titania Extraction)

| | |
|---|---|
| Leaching Process | 5M-7M HCl; 150 °C-200 °C; 1:3 |
| | Solid to Acid ratio |
| Precipitation (Individual | pH 2.0-4.0; 1M-4M NH₄OH; 40 °C- |
| Separation, Rutile and Anatase) | 70 °C. |
| | pH 4.4-6.8; 1M-4M NH₄OH; 40 °C- |
| | 70 °C |

About 5M to 7M hydrochloric acid, HCl was used to leach the titania tailings at 150 °C to 200 °C temperature. Rutile will be precipitated at pH 2.0 to pH 4.0 and Anatase at pH 4.4 to 6.8 respectively using 1M-4M Ammonium Hydroxide between 40 °C-70 °C (Table 8).

TABLE 9
Parameters for Zirconia Extraction (non-REE).
PARAMETERS (Zirconia Extraction)

| | |
|---|---|
| Leaching Process | 7M-9M HCl; 190 °C-230 °C; 1:3 |
| | Solid to Acid ratio |
| Precipitation | 4M-8M NH₄OH; pH 3.5-6.7; 25 °C- |
| | 50 °C |

For leaching process of Zirconia, 7M to 9M Hydrochloric acid, HCl and 190 °C-230 °C will be used to leach the tailings. Then, the precipitation will be conducted at pH 3.5-pH 6.7 using 4M-8M Ammonium Hydroxide between 25 °C-50 °C (Table 9).

TABLE 10
Parameters for Cassiterite Extraction.
PARAMETERS (Cassiterite Extraction)

| | |
|---|---|
| Leaching Process | 9M-11M HCl; 240 °C-260 °C |
| Precipitation | 1M-4M NH₄OH; pH 8.0-9.0; |
| | 40 °C-70 °C |

For leaching process of Cassiterite, 9M-11M Hydrochloric acid, HCl and 240 °C-260 °C will be used to leach the tailings. Then, the of tin will be precipitate at pH 8.0-pH 9.0 and Anatase at pH 8.0-9.0 and using 1M-4M Ammonium Hydroxide, NH₄OH at 40 °C-70 °C (Table 10).

### Overall Extraction Process of Titania, Zirconia, Cassiterite, Monazite, and Xenotime.

Titania extraction is a very long process and needs to be optimized. Important parameters such as molarity and volume of solution, temperature, and pressure are crucial to break the phosphate bond that hold rare earth element (REE). FIG. 11 depicts flow Process of Mineral Extraction.

To break the phosphate bond, the sample needs to be crushed physically to obtain smaller particle size and right thermodynamics are needed as mentioned. Smaller particle size heads to larger surface area for better chemical reaction.

Subsequently, the density separation is conducted onto the tailings to separate the rare earth element (REE), actinides (radioactive element), rutile, siderite cassiterite and other minerals. This density separation will help to separate each element by their density whereas the heaviest element that contain in tailing sample is uranium (19 g/cm³) and Thorium (11.79 g/cm³) and for this stage of actinides removal, density more than 10 g/cm³ will be remove. Density larger than bigger than 6 g/cm³ will undergo the magnetic separation and can separate between REE and Cassiterite. Cassiterite will be separated from the tailing samples and there will be only REE and some low percentage of impurities. Magnetic separation between Monazite and Xenotime is performed, whereby Monazite have high magnetic strength compared to Xenotime.

Density lower than 6 g/cm³ will separate zirconia and titania from element with density more than 6 g/cm³. Zirconia and titania will be separated using magnetic separation where, Zircon 5.0 g/cm³ and Titania (Rutile 4.23 g/cm³) (Anatase 3.69 g/cm³). Physical (density) and magnetic separations are two crucial techniques in this invention before leaching process is conducted.

Monazites have higher magnetic strength, and four minerals (phosphates) are extracted which are cerium (Ce) phosphates, Neodymium (Nd) phosphates, Praseodymium (Pr) phosphates and Lanthanum (La) phosphates. Monazite will undergo the first step of extraction which is leaching process where monazite will be mixed with 11M to 13M hydrochloric acid HCl and reaction occurs between monazite and hydrochloric acid to break the phosphate bond and extract REE from the tailings compound at 280 °C to 320 °C.

REPO₄+3HCl→RECl₃+H₃PO₄

The mixture is then filtered to obtain pregnant solution and the remaining tailing will be check for its inductance. The pregnant solution (PLS) is obtained from this reaction which is RE chloride, RECl₃ and this pregnant solution contain REE that has been leach out from the tailing sample. Then the precipitation is to obtain RE hydroxide by conducted precipitation with 14M to 17M ammonium hydroxide.

RECl₃+3NH₄OH→RE(OH)₂+3NH₄Cl

Furthermore, REE cake (RE(OH)₃) will be dissolved by adding 8M to 10M of nitric acid with 125 °C to 135 °C and the solution will be precipitate to strip the element by individual separation using 5M to 7M ammonium hydroxide until pH 3.8 to 4.0 to obtain Cerium (Ce).

Ce(NO₃)₂+4NH₄OH→Ce(OH)₄+4NH₄NO₃

Neodymium (Nd) and Praseodymium (Pr) are then precipitate by adding 5M to 7M ammonium hydroxide to pH 8.0 to 8.5. Both Neodymium and Praseodymium extracted together because application for both quite similar. The pregnant solution then further precipitate to extract Lanthanum by adding 1M to 3M oxalic acid.

Nd(NO₃)₄+4NH₄OH→Nd(OH)₄+4NH₄NO₃

Pr(NO₃)₄+4NH₄OH→Pr(OH)₄+4NH₄NO₃

2La(NO₃)₃+3C₂H₂OH→La₂(C₂O₄)₃+6HNO₃

There is 60% of Yttrium from the overall of the xenotime composition. Extracting of Yttrium be using with process 2 which start leaching tailings (Xenotime) with 13M to 15M sulphuric acid at 380 °C to 420 °C will have RE sulphate and phosphoric acid.

2(RE)PO₄+2H₂SO₄→RE₂(SO₄)₂+2H₂PO₄

Then, the RE phosphate is filtrate and remaining tailings will undergo elemental analysis and the pregnant solution will be precipitate obtain RE hydroxide by adding 14M-17M Ammonium hydroxide.

RE(SO₄)₄+NH₄OH→RE(OH)₄+(NH₄)₂SO₄

The dissolution process will happen when RE hydroxide dissolve by adding 8M-10M of nitric acid with 125 °C to 135 °C and undergo precipitation by adding 5M-7M ammonium hydroxide to strip the element by individual separation, and Yttrium hydroxide will be obtained at pH 6.0-6.5 and pH 7.5-8.0.

RE(OH)₃+3HNO₃→RE(NO₃)₃+3H₂O

Y(NO₃)₃+3NH₄OH→Y(OH)₃+3NH₄NO₃

The product of each element that has been obtained must be validate its purity. This is very important to sell high purity product due to high market value. RE(NO₃)₃ will be calcined to obtain better yield of REOₓ for selling price.

### Results & Findings

### Tin Tailings Chemical Leaching (Lab Scaled)

Tailing samples is leach under 6M ammonium sulphate solution, followed by 1M oxalic acid precipitation. Crystal-like precipitates observed as the experiment is conducted using saturated chemicals throughout the leaching and precipitation process. Catalyst and autoclave were introduced in the leaching process to increase the maximum yield of RE oxalates. The effect of catalyst and autoclave to the inductance and quality factor were discussed. Bₕ sample was used to replaced B₀ since the real process extraction will start with crushing to get a small particle size and to make sure the minerals bonded were break with each other. From the data, graph of inductance versus frequency and quality factor versus frequency were plotted to see the different of using non catalyst and catalyst to the leaching process.

### Influence of Catalyst in Leaching Process

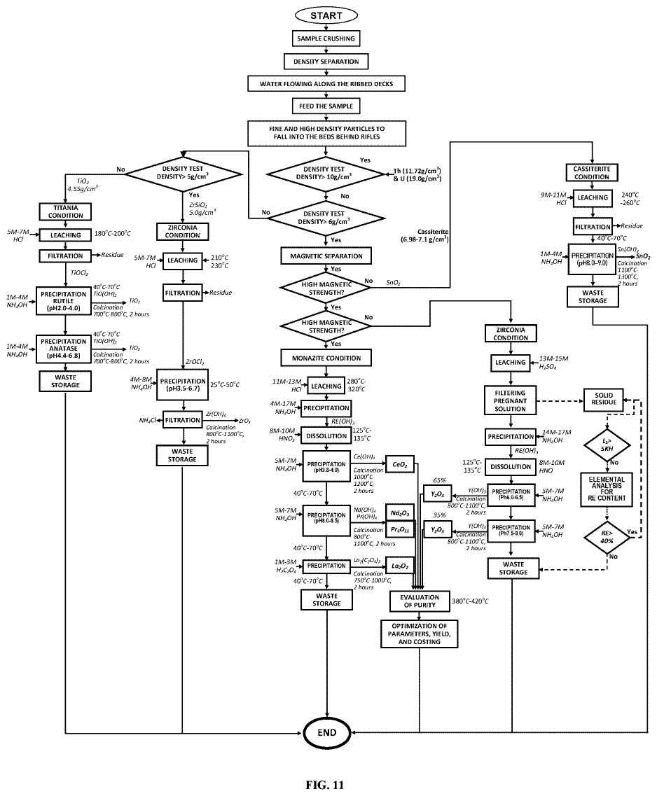

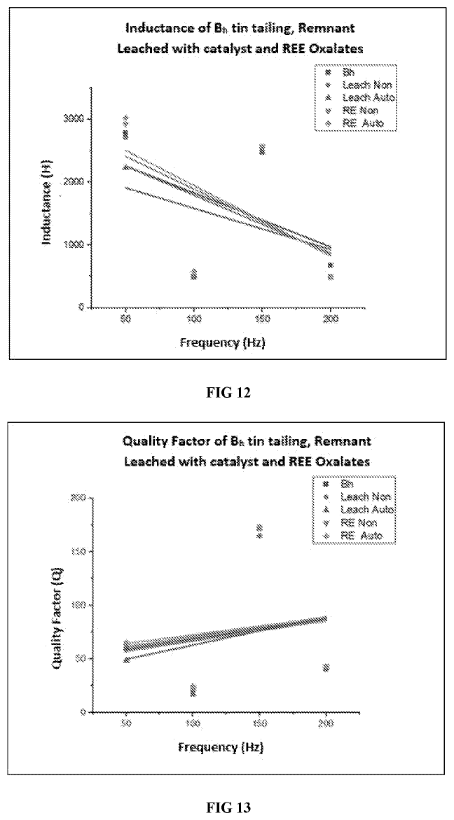

1M hydrochloric acid solution was act as catalyst in the leaching process. Reading of inductance tin tailing and remnant tailing sample (non-catalyst) and (catalyst) were taken at various frequency. Inductance of Bₕ sample can be reduced using non catalyst and catalyst during leaching process. The inductance was reduced to 27.9% with non-catalyst and to 29.1% with catalyst. By using catalyst show a higher reduction compared to non-catalyst and the different reduction is 1.25%. Quality factor of remnant sample (non-catalyst) was reduced to 4.83% while remnant sample (catalyst) increase the quality factor to 0.14%. Remnant sample (catalyst) have a higher quality factor compared to remnant sample (non-catalyst). FIG. 12 depicts Inductance of Bₕ sample, remnant (catalyst) sample and RE oxalates at various frequency and FIG. 13 depicts Quality factor of Bₕ sample, remnant (catalyst) sample and RE oxalates at various frequency.

RE oxalates (non-catalyst) have higher inductance than RE oxalates (catalyst) but the quality factor was same for both RE oxalates (non-catalyst) and (catalyst). The different inductance is 0.29 kH between RE oxalates (non-catalyst) and (catalyst). Even though RE oxalates (catalyst) have lower inductance but the quality still same with RE oxalates (non-catalyst). It showed that, catalyst using 1M hydrochloric acid can increase the rate of kinetic energy by breaking the bond in the tailing and give path for a chemical reaction to take place.

### Influence of Autoclave on Leaching

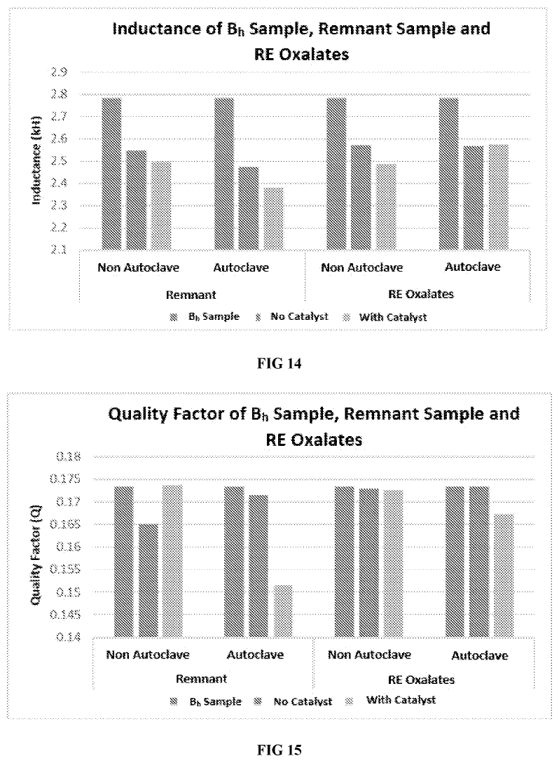

Data using 1M hydrochloric acid using in the leaching process was taken to compare the inductance and quality factor for non-autoclave and autoclave. Using autoclave to the leaching process show a better result in inductance and quality factor reading. Inductance of untreated Bₕ sample can be reduced using both method (non-autoclave) and (autoclave). Means that RE mineral in the B₀ sample were leach out during leaching process. By using autoclave, the inductance of remnant sample was reduced to 5.1% while non autoclave the remnant sample reduced to 0.6%. Higher reduction of inductance happens during autoclave leaching process compared to non-autoclave leaching process. FIG. 14 depicts Inductance of Bₕ sample, remnant (catalyst) sample and RE oxalates at various frequency and FIG. 15 depicts Quality factor of Bₕ sample, remnant (catalyst) sample and RE oxalates at various frequency.

Quality factor for remnant sample (autoclave) is decrease to 12.7% while remnant sample (non-autoclave) increase to 0.14%. Remnant sample (autoclave) have a lower quality factor compared to remnant sample (non-autoclave). Means that, RE mineral are leach out from the sample using autoclave because of lower quality factor. By comparing 2 methods, using autoclave during leaching process can reduced the inductance and quality factor.

### Comparison Between Influence Catalyst and Autoclave to the Tailings and RE Oxalates

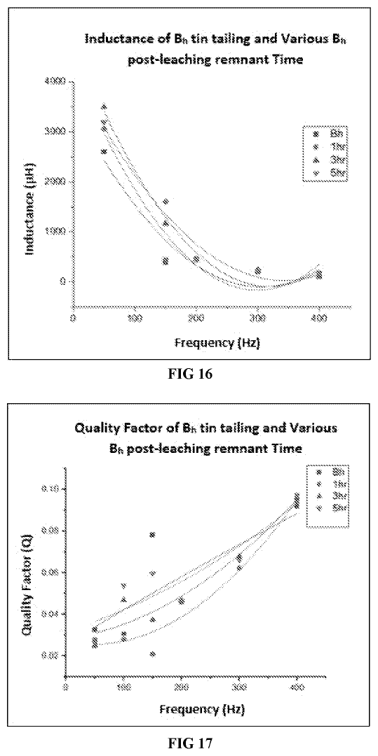

Referring to FIG. 16 and FIG. 17, the influence of catalyst during leaching process can reduce more inductance of sample compared to non-catalyst. The inductance reduces by 11.1% for remnant (catalyst) and 8.5% for remnant (non-catalyst). Same goes to the influence of catalyst in the autoclave reduce more inductances compare to non-catalyst in the autoclave. It was reduced by 14.5% for remnant (catalyst) in autoclave and by 11.1% for remnant (non-catalyst) in autoclave. The percentage different for remnant (non-catalyst) and (catalyst) sample with non-autoclave is 1.93% while remnant sample (non-catalyst and catalyst) with autoclave is 3.36%. Inductance of RE oxalates using catalyst and autoclave is higher compared to other RE oxalates.

Quality factor is reduced by 12.5% for remnant (catalyst) and by 1.1% for remnant (non-catalyst). The percentage different for remnant (non-catalyst) and (catalyst) sample with non-autoclave is 4.9% while remnant sample (non-catalyst) and (catalyst) with autoclave is 11.4%. RE oxalates using catalyst and autoclave shows a bigger rise in quality compared to other method from remnant to RE oxalates.

Using catalyst and autoclave can break bonded RE and other mineral with the tailing to help chemical reaction happen between ammonium sulphate solution and tailings. RE element and other mineral were leach out in the pregnant leach solution and makes inductance decrease while, quality factor may increase or decrease depend on the leach out mineral. If increased, other mineral was reacted with reactant and leach out while RE mineral still bonded with the tailings.

### Time Autoclave Effect

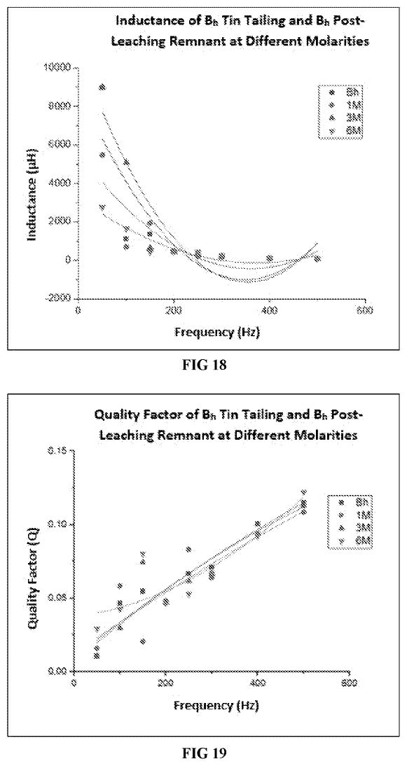

Referring to FIG. 18 and FIG. 19, further experiment was done with time variation of autoclave which are 1, 3 and 5 hours to get the time optimization then the graph were plot. The inductance was increase during leaching process for 1-, 3-, and 5-hours autoclave. 3 hours autoclave have the highest inductance increases followed by 5 and 1 hours. The percentage increase is 34.4% (3 hours), 22.39% (5 hours) and 17.56% (1 hours). Value of R square for 3 hours is 0.981 and the probability is 0.0189 hence, 3 hours represents the preferred time for leaching process.

### XRD Analysis Result

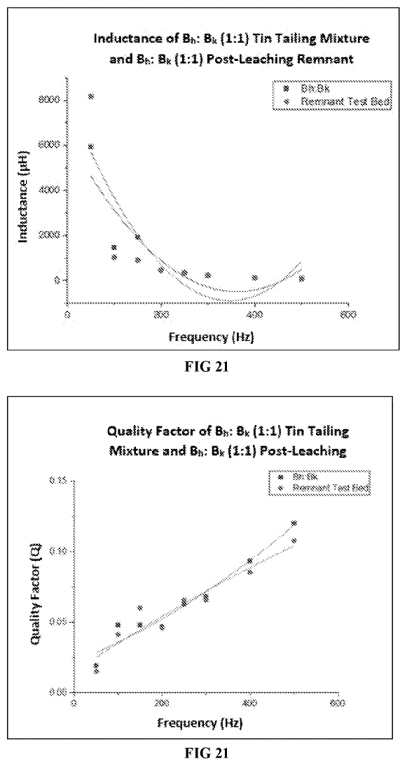

Dry sample of remnant and RE oxalates were send to the XRD analysis. It will focus and measure the high peak of mineral in the remnant and RE oxalates by giving the percentage (FIG. 20). The result is from leach process using 6M ammonium sulphate solution as a leaching agent with 1M hydrochloric solution as catalyst and autoclave at 190 °C for 30 minutes while the precipitate process using 1M of oxalic acid. FIG. 21 depicts X-Ray Diffraction (XRD) analysis of remnant sample (post-leach).

Anatase is totally has leached out using 5M-7M Hydrochloric Acid, HCl with 150 °C to 200 °C thermal condition. Besides, there are also some other elements that have been slightly reduced such as cassiterite and xenotime. The elements like titania and zirconia are increasing after leaching process because other elements are leaching out and these elements starts to appear and can be detected.

### Hydrochloric Acid as a Leaching Agent

Hydrochloric acid is an inorganic acid and commonly used in hydrometallurgical method as a leaching agent to extract mineral and RE elements. It is one of the alternative ways that being used to increase the extraction of RE elements in this tailing. The effect of hydrochloric acid concentration (1, 3, 6 and 9M) on the leaching efficiency was carried out at room temperature and boiling point of the concentration. The wight sample, leaching agent for leach process and molarity of ammonium hydroxide that used in precipitate process are fixed for this condition. The saturation point of hydrochloric acid is achieved between 1 to 6M for both temperatures. Then, the experiment was repeat at the temperature 150 °C for 1 hours fixed with different molarity (1, 3, and 6M).

Referring to FIG. 22, the result shows that, inductance of sample is increase using 3M HCl solution while decrease using 1M and 6M HCl solution. 3M HCl solution increase to 0.4% while 1M and 6M HCl solution reduced to 38.9% and 69.1%, 6M HCl solution have the higher reduction of inductance compared to 1M HCl solution. Value of R square for 6M HCl solution is 0.87 and the probability is 0.0051. Quality factor (FIG. 23) are increasing using 1, 3 and 6M HCl solution which are 49.6%, 1.7% and 176.1%, 6M HCl solution have the highest quality factor followed by 1M and 3M HCl solution. Therefore, 6M HCl solution represents the preferred molarity of HCl solution for leaching process.

Extraction of RE elements was tested in a test bed. 419 g of tailing were feed and mixed with 8 L of 6M HCl solution at 110 °C-150 °C for 3 hours. After it cool, the remnant was taken out to compare the inductance and quality factor. Referring to FIG. 24 and FIG. 25, the inductance is increase to 37.6% and quality factor reduced to 20.9%.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method for rare earth extraction from tin tailing comprising the steps of:
a. crushing the tin tailing and separating heaviest elements to obtain crushed tin tailings without heaviest elements;
b. chemical leaching of crushed tin tailings (non-REE) of step (a) with Ammonium Sulphate (NH₄)₂SO₄, Hydrochloric Acid, HCl; Sulphuric Acid, H₂SO₄ at a temperature ranging from 150 °C to 260 °C for titania, zirconia and cassiterite with pressure ranging from 7 to 10 bar to obtain NON-REE pregnant leach solution;
c. precipitation of obtained non-REE pregnant leach solution from chemical leaching cavity with Oxalic Acid, C₂H₂O₄; Ammonium Hydroxide, NH₄OH; Potassium Hydroxide, KOH and those precipitating agents;
d. filtration and drying of solid precipitate of step (c) prior to elemental analysis for removal of non-REE, impact on REE content and application of further thermodynamics and electromagnetics for REE extraction from chemically leached tin tailings.
e. subjecting the REE to further separation through step (b) to (d) and solid REE Hydroxide to individual separation of rare earth elements;
f. sintering the resulting filtered cake to its respective single-phase oxides at high temperatures.

2. The method according to claim 1, wherein the tin tailing is mechanically crushed with crushing period for 6-8 hours consisting of fine and coarse grain tailing particles.

3. The method according to claim 1, wherein the crushed tin tailing ranges from fine to coarse particles ranging from 0.03 mm to 1.0 mm and mixed at fine to coarse grain proportion of 1:3.

4. The method according to claim 1, wherein the crushed tin tailing heaviest elements of step (a) that have density more than 10 g/cm³ is separated to ensure removal actinides, further consist of Uranium and Thorium.

5. The method according to claim 1, wherein the crushed tin tailing heaviest elements of step (a) that have density about 6 g/cm³ is separated, higher than 6 g/cm³ is REE and Cassiterite whereas lower than 6 g/cm³ is Zircon and Titania.

6. The method according to claim 1, wherein the crushed tin tailing heaviest elements of step (a) of density separation comprises Rutile and Zircon separation through density variation, whereby larger density ranging from 5 g/cm³ and 6 g/cm³.

7. The method according to claim 1, wherein the crushed tin tailing heaviest elements of step (a) having REE and Cassiterite is separated by magnetic separation where the high magnetic element (REE) is separated from low magnetic element Cassiterite.

8. The method according to claim 1, wherein the crushed tin tailing heaviest elements of step (a) having Monazite and xenotime are further separated through magnetic separation technology under magnetic flux density<0.5 Tesla.

9. The method according to claim 1, wherein the non-REE are minerals selected from the group comprising titania, zirconia and cassiterite which is leached first under chemical, thermodynamics and electro-magnetics conditions, followed by acquiring pregnant leach solution of REE that is subjected to individual separation of rare earth Cerium, Neodymium, Praseodymium, Lanthanum and Yttrium.

10. The method according to claim 1, wherein the step (b) of chemical leaching of crushed tin tailings (non-REE) (A) with Ammonium Sulphate (NH₄)₂SO₄; (B) Hydrochloric Acid, HCl; (C) Sulphuric Acid, H₂SO₄ at a temperature ranging from 150 °C to 260 °C for titania, zirconia and cassiterite with pressure ranging from 7 to 10 bar.

11. The method according to claim 1, wherein the chemical leaching of crushed tin tailings (non-REE) is in 200 to 600 mesh sieve and double blade propeller with 120 rpm to 150 rpm to obtain pressurized thermal chemical leaching cavity to ensure the consistent mixing of leaching chemical and tailings under closed high temperature pressurized automation using 150 ml of water then second leach take place range of molarity is 5M to 11M of HCl.

12. The method according to claim 1, wherein the chemical leaching cavity is controlled from optionally with a pressure limit up to 20 bars for designs modifications.

13. The method according to claim 1, wherein the pressurized thermal chemical leaching cavity associated with the micro sieve is filled with chemical (liquid) to tin tailing (solid) to air (gas) ratio of 2:1:2 mimic the chemical and thermodynamics system.

14. The method according to claim 1, wherein the pressurized thermal chemical leaching cavity is associated with solenoid that creates in-situ high magnetic flux density onto the tin tailing, generated magnetic flux disturbs and weaken the intermolecular bond that includes (A) Phosphate Bond; (B) Carbonate Bond; that bind the REE in stable form.

15. The method according to claim 1, wherein the number of turns of solenoid to build high magnetic flux density comprised of 15 turns, 30 turns, 50 turns.

16. The method according to claim 1, wherein the pressurized thermal chemical leaching cavity is associated with capacitive plates that surround the tin tailings that creates in-situ capacitive effect changes during pressurized thermal chemical leaching onto the tailing.

17. The method according to claim 1, wherein the pressurized thermal chemical leaching cavity is associated with Resistivity probe that placed into the tin tailings that creates in-situ resistance measurement during pressurized thermal chemical leaching onto the tailing.

18. The method according to claim 1, wherein the chemical leaching of crushed tin tailings (Titania) performed for 6-9 hours by chemical that includes (A) Ammonium Sulphate, (NH₄)₂SO₄; (B) Hydrochloric Acid, HCl; (C) Sulphuric Acid, H₂SO₄; at different molarities 5M to 7M with 150 °C to 200 °C thermal condition.

19. Then method according to claim 1, wherein, the chemical used for Titania (Rutile and Anatase) precipitation from pregnant leach solution includes (A) Oxalic Acid, C₂H₂O₄; (B) Ammonium Hydroxide, NH₄OH; Potassium Hydroxide, KOH with molarity ranging from 1M to 4M at pH 2.0 to 4.0 and pH 4.4 to 6.8 respectively.

20. The method according to claim 1, wherein the pressurized thermal chemical leaching cavity for Titania is associated with the micro sieve, which is filled with leaching chemical (liquid) to tin tailing (solid) to air (gas) ratio of 2:1:2 to mimic the chemical and thermodynamics system.

21. The method according to claim 1, wherein chemical leaching of crushed tin tailings (Zirconia) is performed for 6-9 hours by chemical that includes (A) Ammonium Sulphate, (NH₄)₂SO₄; (B) Hydrochloric Acid, HCl; (C) Sulphuric Acid, H₂SO₄; at different molarities ranging from 7M to 9M at temperature range of 210 °C-230 °C.

22. The method according to claim 1, wherein the chemical used to precipitate (Zirconia) REE in pregnant solution includes (A) Oxalic Acid, C₂H₂O₄; (B) Ammonium Hydroxide, NH₄OH; molarity is ranging from 0.5M to 1M for Oxalic Acid, C₂H₂O₄ and for Ammonium Hydroxide, NH₄OH is 4M to 8M with thermal condition 40 °C to 70 °C.

23. The method according to claim 1, the pressurized thermal chemical leaching cavity for Zirconia is associated with the micro sieve, is filled with leaching chemical (liquid) to tin tailing (solid) to air (gas) ratio of 2:1:2 to mimic the chemical and thermodynamics system.

24. The method according to claim 1, wherein chemical leaching of crushed tin tailings (Cassiterite) is performed for 6-9 hours by chemical that includes (A) Ammonium Sulphate, (NH₄)₂SO₄; (B) Hydrochloric Acid, HCl; (C) Sulphuric Acid, H₂SO₄; at different molarities ranging from 9M to 11M and 240 °C-260 °C thermal condition.

25. The method according to claim 1, wherein the chemical used to precipitate cassiterite in pregnant solution includes (A) Oxalic Acid, C₂H₂O₄; (B) Ammonium Hydroxide, NH₄OH; Potassium Hydroxide, KOH with molarity ranging from 1M to 4M at pH 8.0-9.0 with thermal condition 40 °C-70 °C.

26. The method according to claim 1, the pressurized thermal chemical leaching cavity for Cassiterite is associated with the micro sieve, is filled with leaching chemical (liquid) to tin tailing (solid) to air (gas) ratio of 2:1:2 to mimic the chemical and thermodynamics system.

27. The method according to claim 1, wherein the precipitated REE cake (solid) of step (e) of step (e) is further processed with dissolution at controlled temperature range from 125 °C-135 °C with varies molarities of Nitric Acid, HNO₃ ranging from (A) 8M; (B) 9M; (C) 10M.

28. The method according to claim 1, wherein the individual solid REE cake solid of step (e) separation is conducting with Hydrochloric Acid, HCl as leaching agent, precipitation for individual separation using 5M to 7M Ammonium Hydroxide, NH₄OH at pH 3.8-4.0 to strip out Cerium and at pH 8.0-8.5 to strip out Neodymium and Praseodymium, then, use precipitation agent 1M-3M Oxalic Acid, C₂H₂O₄ to extract Lanthanum.

29. The method according to claim 1, wherein the individual solid REE Hydroxide of step (e) separation is conducting using 12M-16M Sulphuric Acid, H₂SO₄ as leaching agent, precipitation for individual separation using 5M to 7M Ammonium Hydroxide, NH₄OH at pH 6.0-6.5 and pH 7.5-8.0 to strip out Yttrium.

30. The method according to claim 1, wherein the Anatase content (21.5%) in untreated rare earth tin tailing is dropped to 0% whereby Anatase is leached out entirely with 5M-7M Hydrochloric Acid, HCl under 180 °C to 200 °C thermal condition.

31. The method according to claim 1, wherein the method for rare earth extraction is from tin tailing using chemicals, thermodynamics and electro-magnetics
